(19) United States
(12) Patent Application Publication
(10) Pub. No.: US 2017/0276874 A1
(43) Pub. Date: Sep. 28, 2017

(54) LOW LOSS OPTICAL WAVEGUIDES INSCRIBED IN MEDIA GLASS SUBSTRATES, ASSOCIATED OPTICAL DEVICES AND FEMTOSECOND LASER-BASED SYSTEMS AND METHODS FOR INSCRIBING THE WAVEGUIDES

(71) Applicant: POLYVALOR, LIMITED PARTNERSHIP, Montreal (CA)

(72) Inventors: Raman KASHYAP, Baie d'Urfe (CA); Jerome LAPOINTE, Montreal (CA); Mathieu GAGNE, Montreal (CA)

(21) Appl. No.: 15/618,896

(22) Filed: Jun. 9, 2017

Related U.S. Application Data
(63) Continuation of application No. 15/101,665, filed on Jun. 3, 2016, now abandoned.
(60) Provisional application No. 61/911,148, filed on Dec. 3, 2013.

(51) Int. Cl. G02B 6/13; B23K 26/00; B23K 26/0622; B23K 26/40; B23K 26/53; C03C 23/00; G02B 6/12; G02B 6/134; B23K 103/00

(52) U.S. Cl. CPC G02B 6/13; C03C 23/0025; G02B 6/1345; B23K 26/0006; B23K 26/0057; B23K 26/40; G02B 6/12; B23K 26/53; B23K 26/0624; G02B 2006/12038; B23K 2203/54; B23K 2203/50

(57) ABSTRACT

The method for inscribing a waveguide into a media glass substrate generally has the steps of: relatively moving a femtosecond laser beam along a surface of the media glass substrate while maintaining the focus of the laser beam at a depth of less than the surface, wherein the waveguide has a loss of less than 0.2 dB/cm when measured at a wavelength of light signal propagating in the waveguide during normal use of the waveguide. Particularly, the method can have varying writing parameters according to whether the waveguide is single-mode or multi-mode.

### BACKGROUND

It was known to write waveguides in glass substrates using femtosecond lasers. However, these waveguides are not appropriate for photonic devices since they typically exhibit high loss which inhibits the propagation of light therein. Moreover, it was known to write waveguides deep in the glass, since writing the waveguides closer to the surface could lead to destruction of the glass substrate.

Although existing techniques were satisfactory to a certain degree, there remained room for improvement, particularly in terms of writing low loss waveguides using femtosecond lasers, of writing waveguides closer to a surface of the glass substrate using femtosecond lasers. There also remained room for improvement in terms of providing evanescent wave sensors using near-surface waveguides and of providing a method and a system for encrypting a glass substrate with an encoded waveguide.

### SUMMARY

In accordance with one aspect, there is provided a method for inscribing a waveguide into a glass substrate, the method comprising: relatively moving a femtosecond laser beam along a surface of the glass substrate while maintaining the focus of the laser beam at a depth of less than 100 μm from the surface, wherein the glass substrate is a toughened media glass.

In accordance with another aspect, there is provided a method for inscribing a waveguide into a glass substrate, the method comprising: relatively moving a femtosecond laser beam along a surface of the glass substrate while maintaining the focus of the laser beam at a depth of less than 100 μm from the surface, wherein the glass substrate is an aluminosilicate.

In accordance with another aspect, there is provided a method for inscribing a waveguide into a glass substrate, the method comprising: relatively moving a femtosecond laser beam along a surface of the glass substrate while maintaining the focus of the laser beam at a given depth from the surface, wherein the waveguide is single-mode and has a loss of less than 0.08 dB/cm, preferably less than or equal to 0.07 dB/cm, most preferably less than 0.06 dB/cm, when measured at a wavelength of light signal propagating in the waveguide during normal use of the waveguide.

In accordance with another aspect, there is provided a method for inscribing a waveguide into a glass substrate, the method comprising: relatively moving a femtosecond laser beam along a surface of the glass substrate while maintaining the focus of the laser beam at a given depth from the surface, wherein the waveguide is multi-mode and has a loss of less than 0.08 dB/cm, preferably less than or equal to 0.06 dB/cm, most preferably less than 0.03 dB/cm, when measured at a wavelength of light signal propagating in the waveguide during normal use of the waveguide.

In accordance with another aspect, there is provided a method for inscribing a waveguide into a glass substrate for use as part of an evanescent wave sensor, the method comprising: relatively moving a femtosecond laser beam along a surface of the glass substrate while maintaining the focus of the laser beam at a depth of less than a given distance from the surface, wherein the given distance is a length of an evanescent wave of a light signal propagating in the waveguide during normal use of the evanescent wave sensor.

In accordance with another aspect, there is provided a method for inscribing a waveguide into a glass substrate, the method comprising: relatively moving a femtosecond laser beam along a surface of the glass substrate while maintaining the focus of the laser beam at a depth of less than 45 μm from the surface, preferably less than 40 μm, most preferably less than 35 μm.

In accordance with another aspect, there is provided a method for inscribing a waveguide into a glass substrate, the method comprising: relatively moving a femtosecond laser beam along a surface of the glass substrate while maintaining the focus of the laser beam at a depth where the waveguide is in contact with the surface.

In accordance with another aspect, there is provided an optical device comprising: a glass substrate of toughened media glass having a waveguide inscribed therein at a depth from a surface of the glass of less than 100 μm from the surface.

In accordance with another aspect, there is provided an optical device comprising: a glass substrate of aluminosilicate having a waveguide inscribed therein at a depth from a surface of the glass of less than 100 μm from the surface.

In accordance with another aspect, there is provided an optical device comprising: a glass substrate having a waveguide inscribed therein at a given depth from a surface of the glass, wherein the waveguide is single-mode and has a loss of less than 0.08 dB/cm, preferably less than or equal to 0.07 dB/cm, most preferably less than 0.06 dB/cm, when measured at a wavelength of light signal propagating in the waveguide during normal use of the waveguide.

In accordance with another aspect, there is provided an optical device comprising: a glass substrate having a waveguide inscribed therein at a given depth from a surface of the glass, wherein the waveguide is multi-mode and has a loss of less than 0.08 dB/cm, preferably less than or equal to 0.06 dB/cm, most preferably less than 0.03 dB/cm, when measured at a wavelength of light signal propagating in the waveguide during normal use of the waveguide.

In accordance with another aspect, there is provided an optical device comprising: a glass substrate having a femtosecond-laser inscribed waveguide inscribed therein at a depth from a surface of the glass wherein the waveguide allows an evanescent field of a signal guided therein to extend past the surface during normal use of the waveguide.

In accordance with another aspect, there is provided an optical device comprising: a glass substrate having a waveguide inscribed therein at a given depth from a surface of the glass, wherein the given depth is less than 45 μm from the surface, preferably less than 40 μm, most preferably less than 35 μm.

In accordance with another aspect, there is provided an optical device comprising: a glass substrate having a waveguide inscribed therein at a depth where the waveguide is in contact with the surface.

In accordance with another aspect, there is provided a method for inscribing a waveguide into a glass substrate, the method comprising: relatively moving a femtosecond laser beam along a surface of the glass substrate while maintaining the focus of the laser beam at a depth of less than the surface, wherein the waveguide has a loss of less than 0.2 dB/cm, when measured at a wavelength of light signal propagating in the waveguide during normal use of the waveguide.

In accordance with another aspect, there is provided a method for inscribing a waveguide into a glass substrate, the method comprising: inscribing a first waveguide portion by relatively moving a laser beam on a first length along a surface of the glass substrate while maintaining the focus of the laser beam at a depth less than the surface, the laser beam providing a first amount of energy per unit length of the first waveguide portion; and inscribing a first scattering portion by one of positioning a laser beam at an end of the first waveguide portion while maintaining the focus of the laser beam at the depth less than the surface, the laser beam providing a second amount of energy per unit length of the first scattering portion which is different from the first amount of energy per unit length; and relatively moving a laser beam on a third length along the surface of the glass substrate while maintaining the focus of the laser beam at the depth less than the surface, the laser beam providing the first amount of energy per unit length of the first waveguide portion.

In accordance with another aspect, there is provided an optical device comprising: a glass substrate having a plurality of waveguide portions inscribed along a path of a surface of the glass substrate; and a plurality of scattering portions inscribed along the path of the surface of the glass substrate and interspersed with the plurality of waveguide portions.

In accordance with another aspect, there is provided a system for differentiating an optical device from another, the system comprising: a plurality of optical devices, each one of the plurality of optical devices having a glass substrate having a waveguide having a plurality of waveguide portions inscribed along a path of a surface of the glass substrate; and a plurality of scattering portions inscribed along the path of the surface of the glass substrate and interspersed with the plurality of waveguide portions; an optical signal generator connected to one end of the waveguide and generating an optical signal to be propagated along and into the waveguide portions and through the plurality of scattering portions of the waveguide; wherein each of the scattering portions scatters a corresponding portion of the optical signal out of the substrate glass to form a characteristic scattered optical signal based on the characteristic configuration of the plurality of scattering portions; a sensor for measuring the characteristic scattered optical signal of at least one of the plurality of optical devices; and a computer connected to the sensor for receiving the scattered optical signal and for associating the characteristic scattered optical signal to the corresponding one of the plurality of optical devices.

Many further features and combinations thereof concerning the present improvements will appear to those skilled in the art following a reading of the instant disclosure.

### DESCRIPTION OF THE FIGURES

In the figures,

FIG. 1 is an image showing an example of a focusing device focusing a femtosecond laser beam onto a toughened glass substrate of a smart phone;

FIG. 2 is a bloc diagram illustrating an example of the waveguide inscribing system having a laser beam generator, a focusing device, a moving device and a toughened media glass substrate;

FIG. 3A is a bloc diagram illustrating an example of the waveguide inscribing system having a moving device including the focusing device;

FIG. 3B is a bloc diagram illustrating an example of the waveguide inscribing system having a moving device including the glass substrate;

FIG. 4 is a bloc diagram illustrating an example of the substrate glass having a waveguide inscribed relative to a focused beam;

FIG. 5A is an image of an example of a multi-mode waveguide inscribed in a toughened media glass substrate;

FIG. 5B is an image of an example of a single-mode waveguide inscribed in a toughened media glass substrate and an near-field mode profile view of the single-mode waveguide;

FIG. 6A shows an image of an example of a waveguide inscribed at a distance 25 μm from the surface of a soda-lime glass substrate;

FIG. 6B shows an image of an example of a waveguide inscribed at a distance from the surface of a soda-lime glass substrate;

FIG. 6C shows an image of an example of a waveguide inscribed at a distance 25 μm from the surface of a toughened media glass substrate;

FIG. 6D shows an image of an example of a waveguide inscribed at a distance from the surface of a toughened media glass substrate;

FIG. 6E shows a near field mode profile view of the waveguide of FIG. 6C while the inset i is the same near field mode profile view but with a higher laser power launched into the waveguide of FIG. 6C;

FIG. 6F shows a near field mode profile view of the waveguide of FIG. 6D while the inset i is the same near field mode profile view but with a higher laser power launched into the waveguide of FIG. 6D;

FIG. 7A is a top view of an example of a waveguide inscribed to form a Mach-Zehnder Interferometer (MZI) on a toughened media glass substrate;

FIG. 7B is an oblique view of a schematic representation of the MZI of FIG. 7A;

FIG. 7C is a graph showing an example of a power in dBm as a function of a wavelength of a signal propagated in the MZI where the dashed curved line represents a temperature higher of 10° C. compared to the straight curved line;

FIG. 8 is a bloc diagram illustrating an example of an evanescence wave sensor according to a photonic device disclosed herein;

FIG. 9 is a bloc diagram illustrating an example of a system for differentiating a photonic device from another;

FIG. 10A is a top view of an encoded waveguide having a characteristic configuration of scattering portions inscribed along the waveguide;

FIG. 10B is an example of a characteristic scattered optical signal measured with an infrared camera;

FIG. 10C is an top view of an example of a scattering portion where a waveguide is seen to pass across the scattering portion;

FIG. 11 is a graph showing an example of a return signal power in dBm as a function of a position measured by an optical backscatter reflectometer wherein the return signal includes a backscattered signal and a reflected signal; and

FIG. 12 is a graph showing an example of a loss (measured in dB/cm) as a function of a numerical aperture of a focusing lens used to focus an optical signal along and into a waveguide.

### DETAILED DESCRIPTION

Mobile devices such as smart phones and tablets are becoming increasingly popular. The need for more integrated tools and applications in those mobile devices lead companies to make hardware more compact. Most mobile devices have a screen made of a toughened media glasses such as the well-known Corning™ Gorilla™, due to its mechanical and optical properties.

The disclosure described herein presents optical devices made on a glass substrate. These optical devices generally includes a glass substrate having at least a waveguide inscribed therein. In some embodiments, the glass substrate can be toughened media glass such as used in the screen of some mobile devices. Particularly, this disclosure presents the first high quality waveguides fabricated in this glass type using femtosecond (fs) lasers. Moreover, it was found that the toughened media glass is a suitable material for laser writing of waveguides, especially for three-dimensional (3D) devices. This is of great interest in prototyping photonic devices, and opens the door to high-density optoelectronic integration directly therein.

Recently, the number of devices and tools incorporated in mobile devices has been limited by their size. Some electronic devices may be integrated in the glass screen in order to allow for more space in the smart phone, which could in turn host more tools, and indeed, as it can be shown, novel optical devices can also be integrated in the screen. In this disclosure, some photonic devices are proposed and demonstrated, and their fabrication described. Indeed, using femtosecond laser beam generators to inscribe low loss waveguides in a glass substrate, optical devices such as a temperature sensor and an authentication security system can be created.

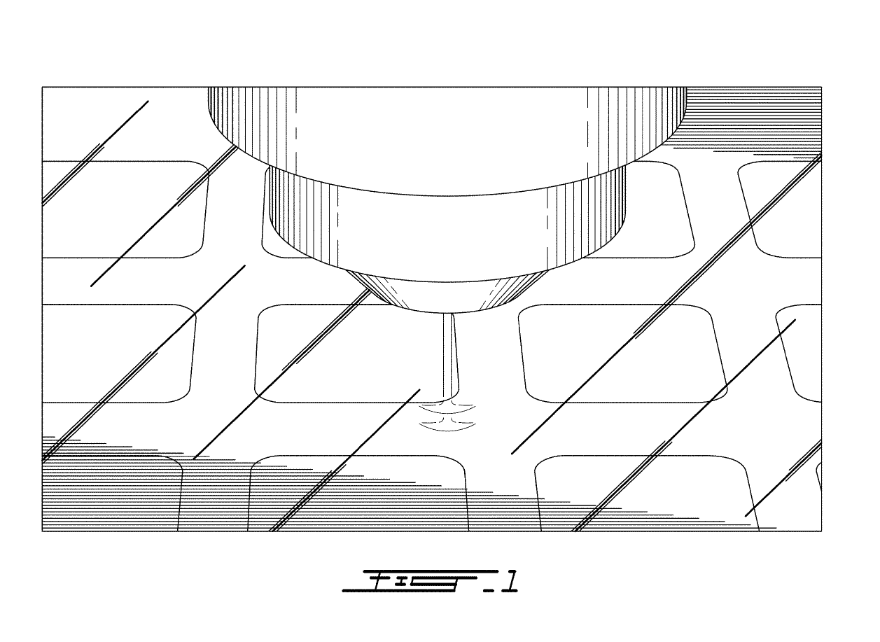

A few technologies are currently available to fabricate waveguides in glass. It is, however, believed that laser writing is a satisfactory process for this application. First, waveguides fabricated using lasers are invisible to the naked eye since they can operate in the infrared region of the electromagnetic spectrum as it can be noticed in FIG. 1. Their fabrication can be easily included as part of a manufacturing step of a smart phone currently on the market. Laser writing is a very simple, quick and cheap process: some waveguides can be fabricated in less than ten seconds. Programming codes for a moving device such as a three-axis motorized stage to set a path of the waveguide can be quick, easy and performed in only one step. No additional cost from the initial laser writing setup is needed. On the other hand, waveguide fabrication techniques such as ion exchange or the in-diffusion process are achieved with phase masks and numerous expensive steps of photolithography inside clean room facilities. Ultimately, laser writing is believed the only technology allowing 3D waveguides to be inscribed, a very valuable capability for smart phone applications as it permits stacking of device layers.

It was known to inscribe waveguides in a glass substrate using a femtosecond laser beam generator. However, the results reported in the literature exhibit losses that limit the propagation of light into the waveguide such as 0.1 dB/cm (in Hirao, K. & Miura, K. Writing waveguides and gratings in silica and related materials by a femtosecond laser. J. Non-Cryst. Solids 239, 91 (1998)) and 0.2 dB/cm (Eaton et al., (2005)), and thus limit the integration of photonic devices therein. Indeed, the waveguides described in the art are characterized by losses far too high for a number of applications, and therefore remains a real barrier to their deployment and use.

Nonlinear absorption in transparent materials occurs via multi-photon interactions at intensities in the vicinity of 10¹³ W/cm², which for an impulse of 100 fs corresponds to energy densities of about a J/cm². Around this energy density, light is seen from the generated plasma, as shown in FIG. 1, and a photo-induced refractive index change occurs. When focusing with lower energies, there is no nonlinear absorption and no material alteration or plasma. Higher energies result in internal cavities or direct material ablation. Thus, there are parameters that need to be optimised to properly inscribe waveguides into the glass substrate.

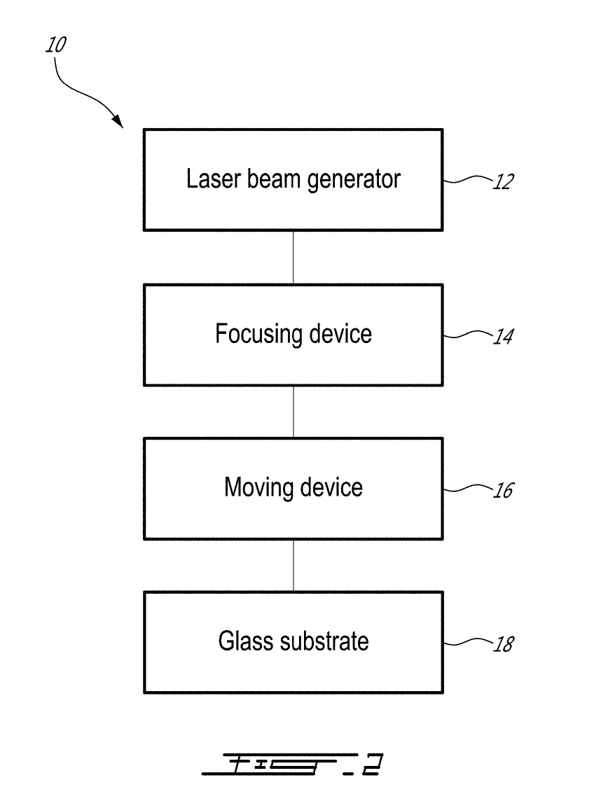

FIG. 2 shows a bloc diagram illustrating an example of a waveguide inscribing system 10 for inscribing a waveguide into a glass substrate. In this example, the waveguide inscribing system comprises a laser beam generator 12, a focusing device 14, a moving device 16 and a glass substrate 18.

Although this particular embodiment has the laser beam generator 12 for generating a laser beam, the laser beam generator 12 can also be a femtosecond laser beam generator 12 for generating a femtosecond laser beam. Typically, the femtosecond laser 12 can be described by a range of wavelength, a repetition rate, a pulse width of the order of the femtosecond (10⁻¹² s), a pulse energy, the numerical aperture of the focusing lens, the number of scan, the polarization of the laser beam, the beam shape and the depth of writing.

For instance, the femtosecond laser beam parameter can vary whether the waveguide to be inscribed on the glass substrate is single-mode or multi-mode. Particularly, the femtosecond laser beam can have a wavelength ranging between 900 nm and 1550 nm, a repetition rate from 300 kHz to 2 MHz, a pulse width from 100 fs to 900 fs, a pulse energy from 550 nJ to 1000 nJ, for instance.

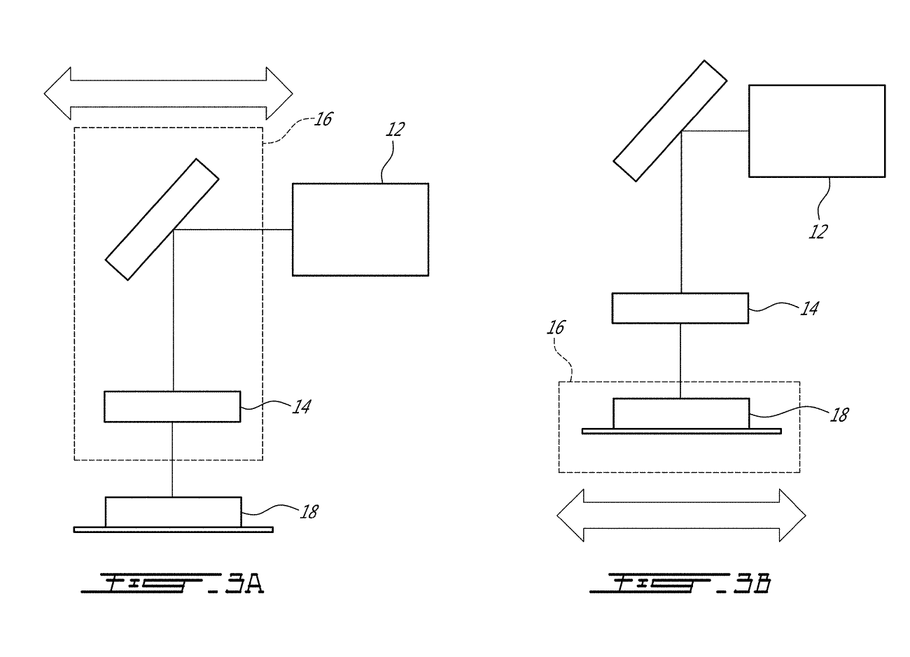

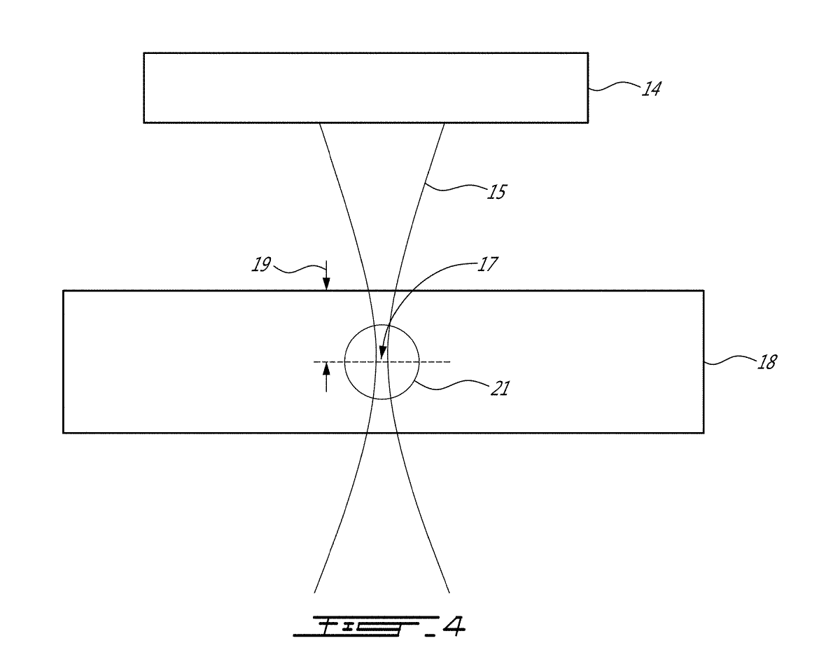

FIGS. 3A and 3B each shows a bloc diagram showing an example of the waveguide inscribing system 10. In each of these figures, the laser beam generator 12 can generate a laser beam to be directed towards the glass substrate 18 via the moving device 16 and the focusing device 14. In the case of FIG. 3A, the moving device 16 includes the focusing device 14. Therefore, the glass substrate 18 remains immobile as the laser beam is moved along a path on a surface of the waveguide. Alternatively, FIG. 3B shows a waveguide inscribing system where the moving device 16 includes the glass substrate 18, and wherein the focusing device is immobile relative to the laser beam generator 12. As it is readily understood by one skilled in the art, the moving device 16 can be a three-axis translation stage and the focusing device 14 can be a lens such as a microscope objective. It is also understood that the moving device could include one or more scanning heads sequentially reflecting the laser beam onto the glass substrate. For instance, the moving device 16 can be adapted to move the laser beam on the glass substrate 18 at a scan speed ranging from 1 to 500 mm/s and the focusing device 14 can focus the laser beam on the glass substrate 18 using a lens having a numerical aperture from 0.4 to 0.8. Indeed, focusing devices having numerical apertures (NAs) of 0.25 and 1.25 have been tried and may be used, although they may not yield satisfactory results. However, NAs of 0.55 and 0.66 can be used to inscribe satisfactory waveguides in a glass substrate. Reference can be made to FIG. 4 showing a bloc diagram of an example of a focusing device 14 directing a focused laser beam 15 into the glass substrate 18. In this example, it can be seen that a diameter of the waveguide is larger than a section of a focal point 17 of the laser beam, since the energy transferred from the focused laser beam to the glass substrate extends beyond the section of the focal point 17. Additionally, the waveguide is shown to be inscribed at a specific depth 19. It is considered that the center of the waveguide can be located at the focal point 17. However, when the waveguide is inscribed close to a surface of the glass substrate, the waveguide may be below the focal point, due to the presence of the surface of the glass substrate 18.

Using the femtosecond laser beam described above, along with a moving device adapted to relatively move the laser beam along a path of a surface of the glass substrate, waveguides having loss down to 0.03 dB/cm (measured at 1550 nm) can be achieved.

As it has been mentioned above, there can be a multitude of combination of writing parameters possible to write a single waveguide on a glass substrate. This specification describes a method for inscribing a single-mode waveguide in the glass substrate, and a method for inscribing a multi-mode waveguide in the same type of glass. In each of these methods, it is therefore understood that as the repetition rate of the femtosecond laser increases, the pulse energy can be reduced. Accordingly, it is preferable that the laser intensity of the focused beam be in the vicinity of 10¹³ W/cm². This threshold may well be much lower for heated substrates.

We believe that important factors to take into consideration to achieve low loss when applying the inscription technique described herein to the glass substrates referred to above and to other types of glass substrates can include i) maintaining a high pulse-to-pulse intensity stability (or otherwise ensuring that the walls of the waveguide are maintained as smooth as possible along the length of the waveguide) and ii) inducing heat in the glass substrate with as little stress as feasible and/or annealing the waveguide after the inscription.

For the multi-mode waveguide, the laser beam can have a wavelength from 900 nm to 1550 nm, a repetition rate from 300 kHz to 900 kHz, a pulse width from 100 fs to 370 fs, a pulse energy from 200 nJ to 500 nJ, the moving device can be set to a scan speed ranging from 1 mm/s to 14 mm/s, while the focusing device can have a lens having a numerical aperture from 0.4 to 0.8. Typically, the waveguides obtained are characterized by a loss of below 0.08 dB/cm, preferably below or equal to 0.07 dB/cm, most preferably below 0.06 dB/cm, when measured at a wavelength of light signal propagating in the waveguide during normal use of the waveguide. It is shown that with this femtosecond laser generator, scan speeds below 1 mm/s fail to inscribe a waveguide in the glass substrate. Indeed, when too much energy is transferred to the glass substrate, defects which limit the light propagation can be observed. However, it is noticed that multi-mode waveguides can be inscribed with a scan speed as high as 20 mm/s, although the scan speed of 10 mm/s can yield a lower loss value.

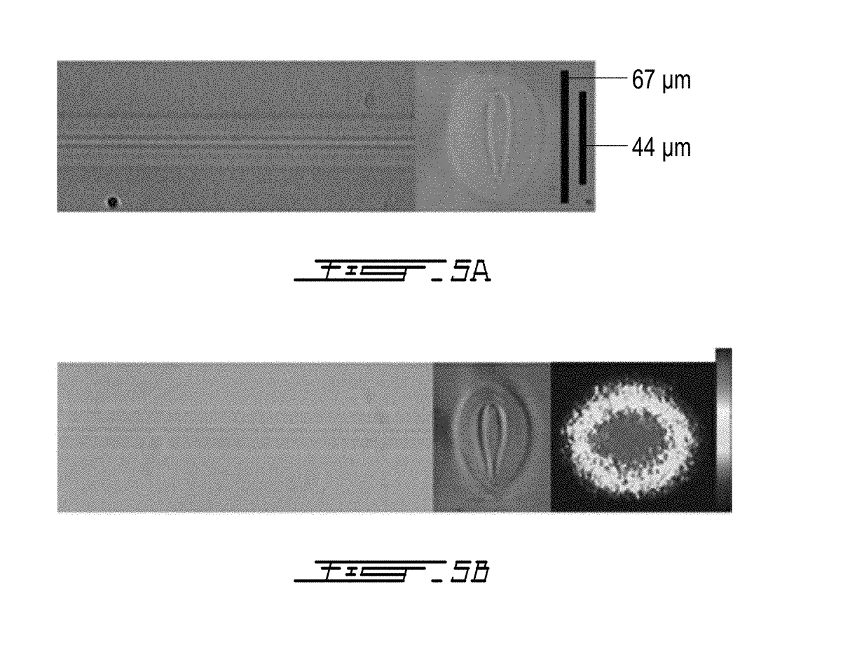

Thousands of waveguides were fabricated in order to find the best writing parameters using two femtosecond laser generators: a 1030 nm wavelength Altos Pharos laser, and a 1064 nm wavelength, Fianium FP1060-2μJ femtosecond laser. The best overall writing parameters to achieve the lowest loss multi-mode waveguides was found using the Pharos laser with a power of 600 mW, a repetition rate of 600 kHz, a pulse width of 300 fs, a 40× focusing lens with a NA of 0.55, in a single scan at a speed of 10 mm/s with circularly polarized light. The waveguide was fabricated 150 μm under the surface of the glass. This particular waveguide exhibited a loss of 0.027 dB/cm at 1550 nm. To our knowledge, this is the lowest loss ever measured through a femtosecond laser generator-fabricated waveguide (see the method section for details on loss measurement). The waveguide is shown in FIG. 5A. The external region has dimensions of 50×67 μm and the internal region, of 13×44 μm. It is believed that the internal region is mainly formed by the pulse's electric field and the external region by the heat accumulation and thus, stress relief. The modes supported by this multimode waveguide seem to be LP₀₁, LP₁₁, LP₂₁ and LP₄₁. The near-fields give mode sizes of approximately 25×32 μm, which suggest that the fundamental mode travels through the internal region and the higher modes through the external region.

On the other hand, certain applications need to use single-mode waveguides to avoid mode mismatch. For the single-mode waveguide, the laser beam can have a wavelength from 900 nm to 1550 nm, a repetition rate from 800 kHz to 2 MHz, a pulse width from 380 fs to 900 fs, a pulse energy from 550 nJ to 1000 nJ, the moving device can be set to a scan speed ranging from 50 mm/s to 500 mm/s, while the focusing device can have a lens having a numerical aperture from 0.4 to 0.8. Although the waveguide inscribing methods described herein use a femtosecond laser generator having a wavelength of 1030 nm or a wavelength of 1064 nm, the waveguide inscription can also work with wavelengths varying from 900 nm to 1550 nm, as long as the laser intensity is enough to cause a refractive index variation in the glass substrate. Furthermore, it is shown that with this femtosecond laser generator, the repetition rate can be reasonably chose to be 1 MHz, which enabled satisfactory waveguides. However, repetition rate ranging from 800 kHz to 2 MHz can be used, as long as the laser intensity is high enough, as mentioned above. Additionally, it has to be noticed that to date, the highest scan speed for inscribing waveguides into a glass substrate was 35 mm/s. One skilled in the art would appreciate that when the scan speed is increased, less energy is transferred to the glass substrate and thus, there is less heat accumulated therein which can provide inscribed waveguides. Therefore, it has been observed that high scan speeds can be suitable for inscribing single-mode waveguides, since high scan speeds can transfer lower amount of energy per unit length and thus inscribe a smaller waveguide and generate a lower refractive index ratio between the refractive index of a core of the waveguide and the refractive index of the glass substrate. Accordingly, a scan speed between 50 mm/s and 500 mm/s can lead to low loss single-mode waveguides. Moreover, it was observed that a scan speed over 500 mm/s can lead to Bragg gratings inscription, instead or single-mode waveguides inscription, since the inscription in the glass substrate can be only periodic due to a distance between two successive pulses. Typically, the waveguides obtained are characterized by a loss of below 0.08 dB/cm, preferably below or equal to 0.06 dB/cm, most preferably below 0.03 dB/cm, when measured at 1550 nm.

In order to reduce the number of guided modes, two standard parameters need to be controlled: the refractive index difference between the core n₁ and the cladding n₂, Δn=n₁-n₂, of the waveguide, and the waveguide core diameter, so that the normalized frequency V (or V-value) for a waveguide in a cylindrical geometry remains below 2.405, as it is readily known in the art. Curved or waveguides with bends, which are important for future applications, generate higher losses when the Δn is low. It is also not easy to control and measure the refractive index change resulting from the use of the femtosecond laser generator. Moreover, the waveguide diameter can be seen under the microscope. To reduce the diameter, one can reduce the power or increase the speed of laser scan. Reducing the power may not be a practical solution in our case as the power needed to obtain nonlinear absorption is very high. The repetition rate of the laser Altos Pharos can be set between 1 kHz and 600 kHz. The scan speed needed to make a single-mode waveguide was found to be too high, thus the distance between two laser pulses was found to be too long and, therefore, the refractive index change induced in the glass was periodic. A phenomenon suitable for the fabrication of Bragg gratings. Single-mode waveguide fabrication was finally possible using the Fianium femtosecond laser generator, due to its higher repetition rate. The best single-mode waveguide was fabricated using the following parameters: power of 630 mW, repetition rate of 1 MHz, pulse width of 500 fs, 40× focusing lens with a NA of 0.55, one scan at a speed of 300 mm/s with a circularly polarized light. The waveguide was located 150 μm under the surface of the glass. This waveguide exhibits a loss of 0.053 dB/cm; again, to our knowledge, the lowest loss ever measured for a single-mode waveguide fabricated using femtosecond laser inscription. It is also the fastest fabrication process among all the existing methods reported so far.

FIG. 5B shows the single-mode waveguide. The size of the external region of the waveguide is ˜37×53 μm, which is significantly smaller than for the multimode waveguide. The size of the internal region is ˜13×35 μm, similar to that found in the multimode waveguide. The circular near-field mode profile diameter is 11 μm, which confirms that the light is confined only in the internal region. Note that all waveguides have an oval shape. Circular shapes can be made by using cylindrical lenses or a slit (Ams, M., Marshall, G. D., Spence, D. J. & Withford, M. J. Slit beam shaping method for femtosecond laser direct-write fabrication of symmetric waveguides in bulk glasses. Optics Express. 13, 5676-81 (2005)., and Yang, W., Corbari, C., Kazansky, P. G., Sakaguchi, K. & Carvalho, I. C. S. Low loss photonic components in high index bismuth borate glass by femtosecond laser direct writing. Optics Express. 16, 16215-26 (2008).) which generate an elliptic beam just before the focusing lens. In addition, a low loss multimode waveguide written using the Fianium laser with the same parameters used with the Pharos laser at a scan speed of 10 mm/s gave a measured loss of only 0.08 dB/cm.

To prove that these results can be reproduced on mobile devices, electronic tablets and other larger multimedia devices, 30 cm long straight waveguides were fabricated in toughened media glass using the same writing parameters. Identical losses were measured. To our knowledge, these are the longest straight waveguide ever fabricated using a fs laser. Using the 0.027 dB/cm loss writing parameters, we fabricated a one-meter-long curved multi-mode waveguide. This waveguide has an “S” shape: first in a straight line of 25.1 cm, followed by a half circle of radius 4.75 cm, a straight line of 20.1 cm, then another half circle with a radius of 4.75 cm and finally a straight line of 25.1 cm. This waveguide is the longest curved waveguide ever fabricated. The total measured loss was 24 dB. From this we can obtain the loss generated by the curve to be 0.38 dB/cm, which is significantly higher than for the straight waveguides. The average loss for the 1 m long waveguide was still only 0.24 dB/cm. We also fabricated a few simple devices in toughened media glass (50%/50% coupler, 75%/25% coupler, 1×2 and 1×4 splitters) and all resulted in an additional loss of less than 0.5 dB over the entire device. The curvature needed to separate two waveguides requires a deviation of only 100 μm over a certain distance needed to form the couplers which only generates relatively low loss. However, certain applications such as loop cavity resonators or Sagnac interferometers need a curve over a relatively long distance. Note that the Sagnac interferometer is used to measure angular velocity [21, 22], which is of great interest for mobile multimedia devices. Even if 3D laser writing allows helical waveguide where the number of loops, N, multiplies the Sagnac effect per turn, small multimedia devices still need tight bends. For this purpose, we studied the loss as a function of radius of curvature. For a 5 cm radius of curvature, we obtained 0.7 dB/cm, for 4 cm: 1.2 dB/cm and for 3 cm: 2.4 dB/cm. All of these were measured over a quarter circle. These results show that there is a great opportunity for improvement. Increasing the refractive index of the waveguide would solve this issue. It is believed that inducing lower refractive index on either side of a waveguide using higher laser power (which would compress the waveguide) may prove to be a solution. However, this may be visible to the naked eye. Nevertheless, this method could be a solution in the glass surrounding the display area.

In this case, the glass substrate can be made of a toughened media glass material or a toughened glass material. These types of glasses have been shown to considerably reduce the loss of single-mode or multi-mode waveguides inscribed therein. Moreover, these types of glass have a top layer strengthened with an ion exchange process. It is believed that the induced refractive index change in the toughened media glass is highly dependent on the high internal stress therein. Rather than being a simple damage induced refractive index change, stress relief as in the case of type IIA refractive index change in fiber Bragg grating could also participate in the process. In the case of the fiber, accumulated stress between the core and the cladding of certain types of fiber is released during grating inscription, inducing a negative index change around the core, allowing much stronger index modulation. In the present case, stress relief would induce a lower index region around the waveguide that would further enhance the guiding properties without the need of higher laser power which creates defects. This could explain the significantly lower loss induced in toughened media glasses compared to other glasses.

It is also believed that low loss waveguides in toughened glasses could be due to the quality of the core-cladding interface. Interface roughness generates losses as roughness induces scatter. It is believed that the metallic ions in the toughened media glass soften this interface by filling in the irregularities. The two assumptions put henceforth, however, require confirmation with further investigation. Precise determination of the refractive index profile of the two waveguide section areas (parallel and perpendicular) could possibly help confirm our model.

In this specification, the term toughened media glass can be referred to other type of glass having a strong layer thereon. The strong layer can be obtained by a (or more than one) process(es) including thermal and/or chemical treatments. These treatments can thus increase the strength of a layer of the glass substrate compared to an unprocessed glass substrate. The strong layer may result from an ion exchange process which induce a compressive residual stress on the strong layer, which can prevent crack from propagating upon an impact. It is known to reinforce glass by incorporating potassium ions, for instance. These types of glass may be suitable for use in media devices such as smart phones, electronic tablets, portable media players, laptop computers, and/or any electronic displays. Preferably, the toughened media glass can be an aluminosilicate, an alkali aluminosilicate, or an alkaline earth boro-aluminosilicate. An example of an alkali aluminosilicate can be a Gorilla™ glass made by Corning™ or the Dragontrail™ made by AGC™ while an example of an alkaline earth boro-aluminosilicate can be an EAGLE XG™ glass made also by Corning™.

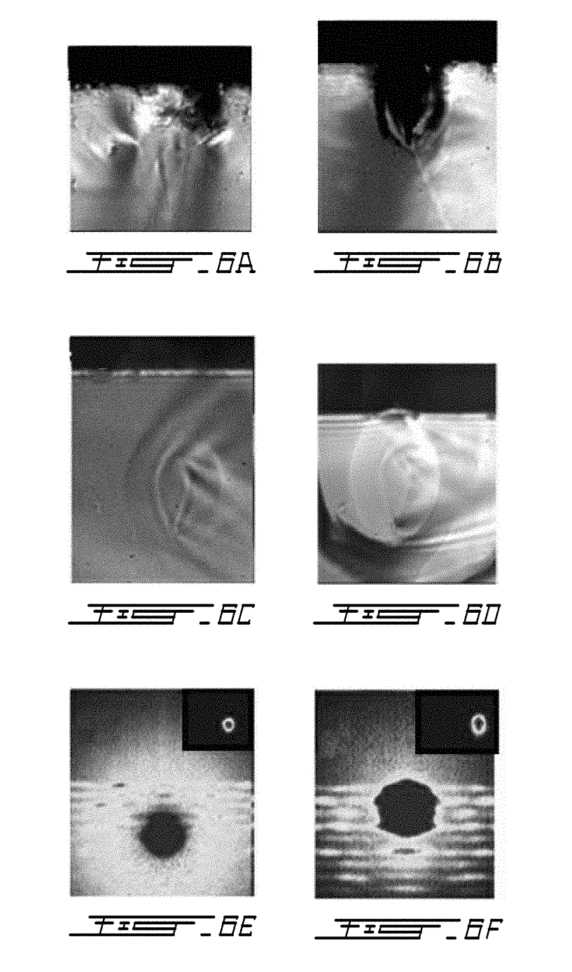

Three dimensional laser writing provides the possibility to fabricate compact devices. A compressed strong layer each side of a toughened media glass protects the glass from ablation and allows waveguide writing closer to the surface. FIGS. 6A and 6B show examples of a front view of waveguides written close to the surface in Corning 0215 soda-lime glass, while FIGS. 6C and 6D show examples of a front view of waveguides written close to the surface in a toughened media glass, using the same writing conditions. Note that the soda-lime glass is probably the most commonly manufactured glass, as it is used to make windows, bottles and numerous of other commercial products. Even at 25 μm below the glass surface, the toughened media glass does not show much difference from deeper written waveguides (see FIG. 6C). On the other hand, the soda-lime glass cracks easily, ablates and shatters, see FIGS. 6A and 6B. Even when the top of the waveguide touches the glass surface, the toughened media glass waveguide is in good condition showing typically 5% higher measured loss (FIG. 6D), while ablation occurs in the soda-lime glass (FIG. 6B). Note that for optimizing waveguides at different depths of writing, the writing parameters can be optimized slightly (Kowalevicz, A. M., Sharma, V., Ippen, E. P., Fujimoto, J. G. & Minoshima, K. Three-dimensional photonic devices fabricated in glass by use of a femtosecond laser oscillator. Optics Letters. 30, 1060-2 (2005).). FIGS. 6F and 6H are examples of the circular near-field mode profiles of the surface waveguides shown in FIGS. 6C and 6D, respectively. To see how close to the surface those near-field modes are, higher laser power has been launched in the waveguides, which is shown in the insets i and ii of FIGS. 6E and 6G, respectively. As it can be seen from the figures of FIG. 6, attempts to inscribe a waveguide close to the surface in the soda-lime glass were unsuccessful, as cracks can easily propagate once the glass is broken due to the femtosecond laser. However, these experiments revealed that the toughened media glass seems to be an ideal host for inscription of waveguides at a given distance just below the surface of the glass substrate, which can be of great interest in sensing applications. As seen in FIG. 6C, the given distance can be as small as 25 μm, and even smaller as it can be seen from FIG. 6D. Although FIG. 6C shows an example of a waveguide written at a distance of 25 μm from the surface, it is believed that no waveguide being inscribed at a distance below 45 μm has been reported.

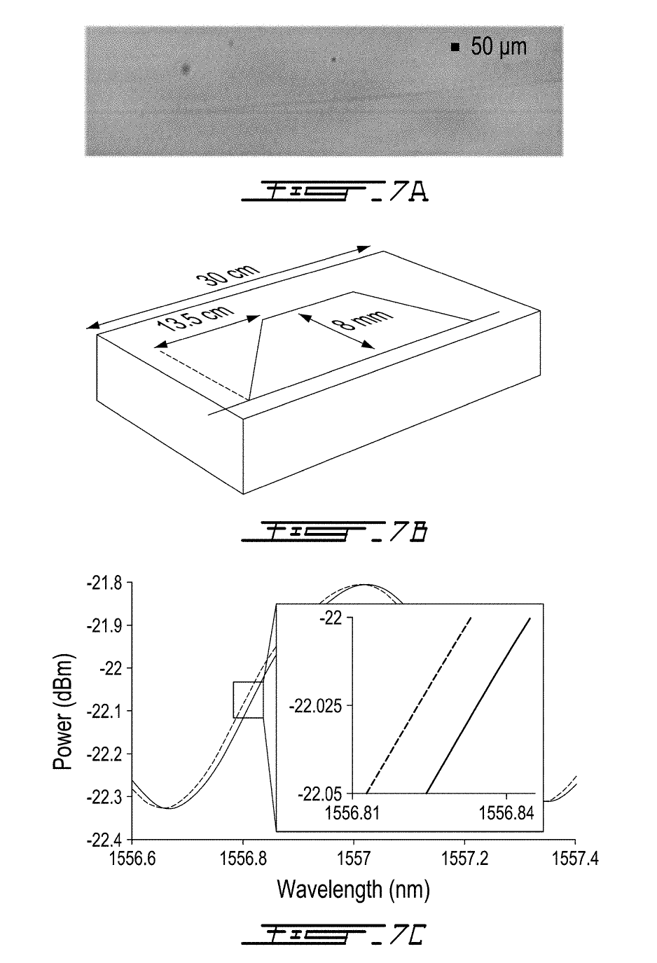

In another embodiment, photonic devices such as optical sensors can be designed at the surface of the toughened media glass. For instance, a Mach-Zehnder Interferometer (MZI) based temperature sensor. This very precise device is well known and has already been fabricated in different glasses using lasers (Della Valle, G., Osellame, R. & Laporta, P. Micromachining of photonic devices by femtosecond laser pulses. J. Opt. A: Pure Appl. Opt. 11, 013001 (2009).). However none with written with a laser to form a low loss waveguide. The MZI is made of a straight waveguide and another curved waveguide as shown in FIGS. 7A and 7B. The optical path difference between the two arms is n_{d}=480 mm. A part of the MZI output spectrum at room temperature is shown on FIG. 7C. The light intensity at the output of an MZI is calculated using the following formula:

$$I = {I}_{1} + {I}_{2} + 2 \sqrt{{I}_{1} {I}_{2}} cos ( \frac{2 π {n}_{d}}{λ} ) ; \qquad ( 1 )$$

where I₁ and I₂ are the light intensities in the two arms of the MZI, and λ is the wavelength of the light. The thermal expansion coefficient of the toughened media glass is typically 9.1×10⁻⁶ ° C.⁻¹ (Corning, Corning Gorilla Glass Technical materials. Retrieved Oct. 11, 2013, from Corning Web site, (2008)), which is about nine times that of the silica (Kashyap, R. Fiber Bragg Gratings Second edition, (London, Academic Press, 2009).). This means that the intensity change at the output is the same as a silica based device, but in a smaller footprint. Using equation (1), the thermal coefficient and the path difference, we can obtain the wavelength shift in the spectrum. The red dashed curve in FIG. 7B is the theoretical spectrum after increasing the temperature by 10° C. The theoretically calculated values seem to agree with the experimental measurements, which were made using a heat gun; therefore, the precise setting of temperature was not easy to obtain. This wavelength shift can be easily obtained by measuring the output power from a monochromic light source.

The MZI precision can be enhanced by increasing the contrast, also called visibility v, of the fringes at the output:

$$v = \frac{2 \sqrt{{I}_{1} {I}_{2}}}{{I}_{1} + {I}_{2}} \qquad ( 2 )$$

To maximize the visibility, the intensity in the two MZI arms can be identical. To obtain this result, the MZI input coupler (FIG. 7A) can be symmetric. An application of this temperature sensor could be to detect overheating in a mobile multimedia device. In our current demonstration, the MZI is very long (almost 300 mm); despite this, the loss is sufficient low for the device to operate easily. It is, of course, possible to make the device much smaller for application incorporated in mobile devices.

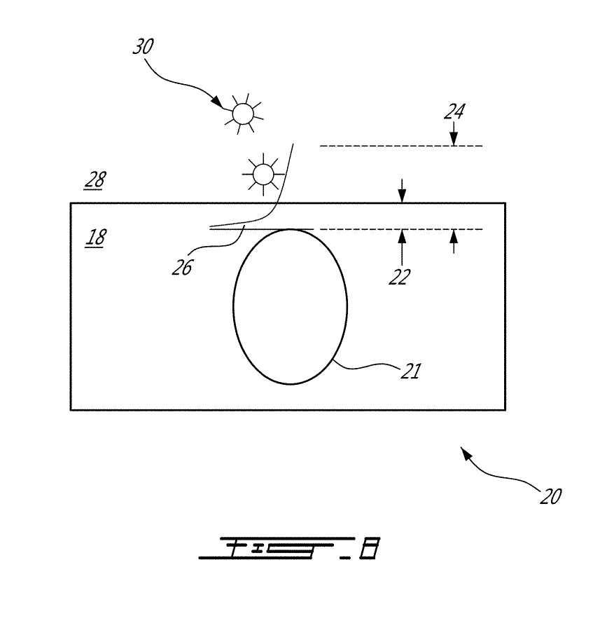

In another embodiment, the photonic device can be an evanescent wave sensor 20 as which an example is illustrated in FIG. 8. Indeed, when a waveguide 21 is inscribed into a glass substrate 18 at a distance 22 of below a penetration distance 24 of an evanescent wave 26 from the waveguide, the evanescent wave can sample an environment 28 adjacent to the surface of the glass substrate 18. By doing so, a refractive index change in the environment 28 can interact with a sampling signal propagating along the waveguide 21 via the evanescent wave. Therefore, when a concentration of an analyte 30 changes as a function of time, for instance, the sampling signal can be modified which allow sensing.

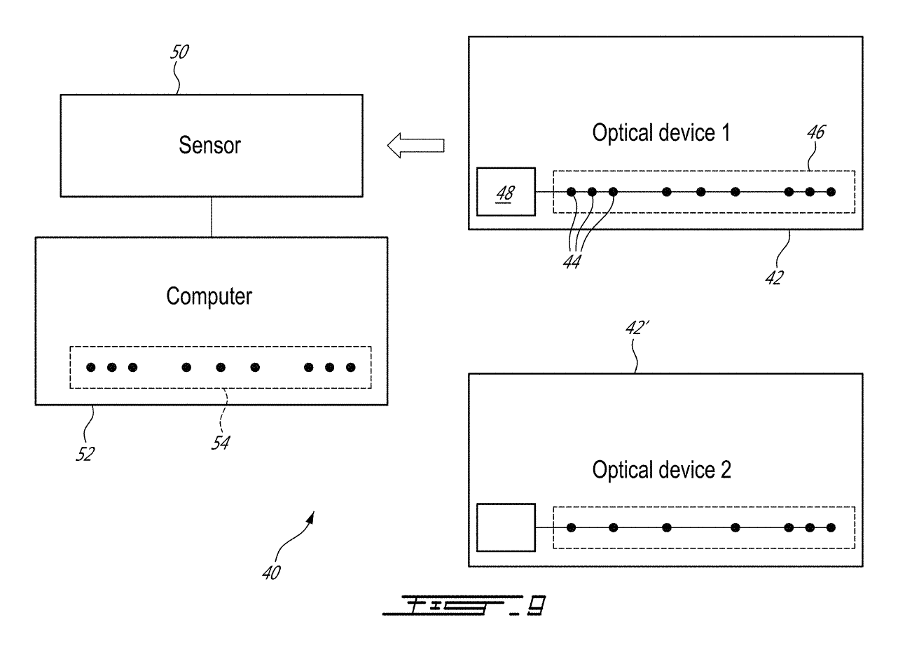

In another embodiment, the photonic device can be implemented in a system for differentiating an optical device from another 40 which is illustrated by the bloc diagram of FIG. 9. It is understood that the photonic device (or optical device) includes a substrate glass at least having a waveguide inscribed therein. Although the system can differentiate a substrate glass having a waveguide from another substrate glass having a waveguide, the system also can differentiate a substrate glass having a waveguide inscribed therein from a substrate glass having no waveguide written therein, for authentication and anti-counterfeiting purposes. In this embodiment, the system 40 can include one optical device 42 or more optical devices 42′, where the optical device 42 has a glass substrate 18 having an associated waveguide 21 inscribed along a path of a surface of its glass substrate 18 and obtained by relatively moving a laser beam while maintaining the focus of the laser beam at a depth close to the surface, the waveguide being inscribed in the glass substrate by providing an amount of energy per unit length of the waveguide using the laser beam. Now, for each of the optical devices, a plurality of scattering portions 44 (illustrated by black dots) can be inscribed along the path of the surface of the glass substrate and obtained by positioning a laser beam on the waveguide while maintaining the focus of the laser beam at the depth below the surface. In the case of the scattering portions 44, a second amount of energy per unit length of the waveguide using the laser beam and which is different from the amount of energy per unit length can be provided. For instance, the second amount of energy per unit length can be obtained by modifying the scan speed of the laser beam at a position of the waveguide. In this example illustrated in FIG. 9, the scattering portions 44 were obtained by maintaining the laser beam at a given position along the waveguide for a second. It is noted that the scattering portions 44 can be disposed in a characteristic configuration 46 relative to one another along the waveguide 21. Henceforth, each optical device can have its own particular characteristic configuration.

Each of the optical devices of the system 40 further includes an optical signal generator 48 connected to one end of the waveguide 21 to generate an optical signal to be propagated along and into the waveguide 21 and through the scattering portions 44. Furthermore, the scattering portions 44 can scatter a corresponding portion of the optical signal out of the substrate glass to form a characteristic scattered optical signal based on the characteristic configuration 46 of the scattering portions 44. Therefore, the characteristic scattered optical signal of optical device 42 can be different from the characteristic scattered optical signal of optical device 42′. Henceforth, a sensor 50 can be used to measure the characteristic scattered optical signal of at least one of the two of optical devices 42 and 42′. In FIG. 9, the sensor 50 measures the characteristic scattered optical signal scattered from the optical device 42. Accordingly, a computer 52 connected to the sensor 50 can associate the measured characteristic scattered optical signal to one of the optical devices 42 and 42′. Alternatively, the computer can be used to determine that the measured characteristic scattered optical signal may not be associable to one of the optical devices 42 and 42′ since the optical device measured have no encoded waveguide inscribed therein. This features enables to authenticate an optical device having an encoded waveguide from a simple glass substrate. Still referring to FIG. 9, the measured scattered optical signal illustrated at 54 corresponds with the characteristic configuration of scattering portions of the optical device 42. As one skilled in the art may appreciate, the computer can be a computing device having at least a processor and/or a microprocessor. Moreover, the sensor can be a type of sensing device adapted to detect any order of magnitude and any wavelength of the light that is to be scattered out of the encoded waveguide.

For instance, this method for differentiating an optical device from another is believed implementable in mobile devices having a substrate glass thereon. With such an embodiment, illegal cloning of credit cards, which is increasing and becoming widespread by scanning using non-contact means, can be avoided. The trend in smart phones technology is to integrate features from different technologies (internet, camera, telephony . . . ) and authentication will most likely be included in future high end smart phones. Therefore, to further improve security, biometrics such as eye or finger print scanning technology can be used to add another level of security, however, these schemes may prove to be too complicated to become mainstream in the hardware of devices.

The simple technique proposed in the instant embodiment can propose a simple technique which can be integrated into any smart phone to improve an authentication security. In the scheme illustrated in FIG. 9, smart phone identification is based on simple optically encoded information in the screen of a cell phone, using an encoded waveguide having a characteristic configuration of scattering portions written thereon. The characteristic scattered optical signal (or spatially encoded image) which is scattered out of the waveguide made integral to the substrate glass may be read out optically using a sensor such as an infrared camera. The encoded information (or characteristic configuration of scattering portions) can be randomly generated using an algorithm. The bend radius, along with the higher associated loss, may also be used in conjunction with the encoded information for encryption.

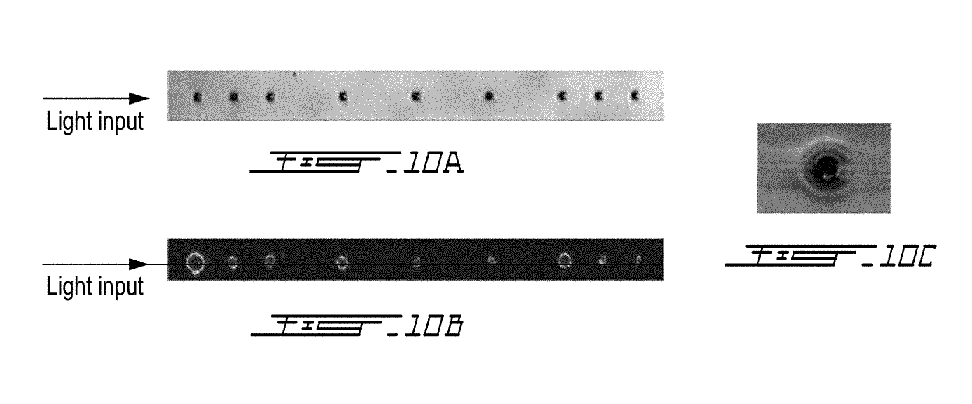

To demonstrate such a system, a fluorescent sheet placed in front of a Charge-Coupled Device (CCD) camera (or sensor) to detect the infrared light (characteristic scattered optical signal) scattered out of the waveguide being encoded with scattering portion therealong. This proof of concept was performed by fabricating scattering portions having a high scattering loss. FIG. 10A shows an example of a top view of a characteristic configuration of scattering portions, FIG. 10B shows an example of the measured characteristic scattering optical signal measured using the infrared camera while FIG. 100 shows an example of a top view of a scattering portion. For instance, the characteristic configuration of scattering portions is encoded according to the standard emergency Morse code “SOS”: three dots, three dashes, followed by three dots. Each dot has been fabricated simply by pausing the laser at the relevant position for a second. The distance between two consecutive dots can be 200 μm.

For instance, the photonic device can incorporate an optical signal generator connected to the encoded waveguide, the optical signal generator can be adapted to generate and further propagate a light signal along the encoded waveguide. For instance, high laser power lasers diodes can be satisfactory for this purpose, although optical laser diodes having a power of 3 mW can be sufficient to provide enough power to twenty of the scattering dots shown in FIG. 10A. These twenty scattering dots can be used to provide 2³⁰ different on-off key combinations. It is therefore noted that the CCD camera can be adapted to measure a scattered signal power from a scattering dot having a power of 0.01 μW. As will be appreciated by one skilled in the art, if the sensitivity of the sensor is very low, the scattering portion can be inscribed in the glass substrate while maintaining the focused laser beam for a longer maintaining time of two seconds (instead of one second) which can cause the scattering portion to scatter a larger portion of the light signal. Furthermore, it is understood that the maintaining time of the focused laser beam in the glass substrate can vary along the length of the encoded waveguide, since a certain portion of the light signal can be scattered out of the waveguide as a function of a propagation distance and a number of scattering portion passed through.

Other characteristic configuration of scattering portions can be provided. For instance, these scattering dots can generate a large number of keys or encryption combination in only a small area. For example, writing a dot (binary 1) or an absence of dot (binary 0) every 100 μm could generate over 10¹⁵ different keys in a 1 mm² area. A total insertion loss of 10 dB is estimated given a loss of 0.2 dB/scattering portion for the worst case of an all 1's key. Indeed, the scattering portions can be obtained by providing a second amount of energy per unit length which is greater than a first amount of energy length provided to inscribe the waveguide. Alternatively, it is readily understood that the high scattering loss of the scattering portions can be provided by a waveguide portion having a curved path. Indeed, the scattering portions can be obtained by relatively moving the focused laser beam along a curved path. This curved path can thus scatter light outside the waveguide through curvature losses. Furthermore, the use of curved waveguides, splitters, Bragg gratings, wavelength-division multiplexers (WDM) and demultiplexers to separate the wavelengths, could render these keys very complex, thus increasing the difficulty of reproducing a unique encoded waveguide which can limit counterfeiting.

Although the given loss for a scattering portion was measured to be 0.2 dB in our experiments, the encoded waveguide can be inscribed with scattering portions having a lower and/or a higher scatter susceptibility. Indeed, sensors can be adapted to detect down to 0.01 μW per scattering portion (perhaps even down to 10 nW). For instance, if a loss budget of 10 dB of loss is considered for a 10 mm long waveguide having a squared area of one millimetre squared and which has 10 waveguides sequentially coupled one to the other, and which are laterally spaced one from the other by 0.1 mm. Then, a scattering portion can be inscribed every 0.1 mm, and 100 scattering portions can be managed with the loss budget of 10 dB. In this situation, each scattering portion can have a loss of 0.1 dB loss per scattering portion. Indeed, this can be sufficient and the loss can even be far less than half of this value and still be detectable. For example, one may launch 1 mW into the encoded waveguide, this means only 10 μW scattered per scattering portion. Even if this was 10 nW per scattering portion, it can be detectable, which means a total loss of only 1 μW for 100 scattering portions, leaving 99.9% of the light in the waveguide untouched (from 1 mW).

Moreover, with photonic devices having waveguides, injecting a light signal into the waveguide can be difficult. In another embodiment, one (or more than one) scattering portion(s) can be used to measure an injection efficiency indicative on an alignment in which the light signal is injected in the waveguide. Indeed, by measuring a scattered light scattering from the scattering portion, one can optimize the alignment of the light signal in order to adequately inject the light signal into the waveguide. Generally, the light injection can be optimized by maximizing the measured scattered light from the scattering portion. Henceforth, an alignment efficiency can be determined based on the measured scattered light.

It was disclosed here a method for inscribing low loss waveguides on a toughened media glass substrate at a distance close to a surface of the toughened media glass substrate using femtosecond laser inscription. This method was used to fabricate multi-mode waveguides having a loss below 0.03 dB/cm. Moreover, it is demonstrated that there is a mode-dependent loss present in femtosecond laser written waveguides, for the first time.

Exciting the lowest order mode gives the lowest loss for the waveguide, but with a low NA. It may be possible to improve the NA by the judicious use of the laser to embed lower refractive index regions close to the waveguide. The stress profile of the toughened media glass appears to assist in the reduction of loss, which we believe is primarily due to enhanced scatter. Also for the first time, we believe we have shown that these waveguides may be written just below the glass surface in toughened media glass, probably assisted by the stress profile, not possible in other glasses due to ablation problems. Further, we have written ultra-long waveguides, up to 1 m long in this glass, demonstrating the possibility of integrating photonic devices into multimedia glass, such as smart phones and displays. Indeed, the encoding of information can be a technique for encrypting waveguides. Also demonstrated is an interferometric MZI device capable of sensing temperature in the same glass, opening possibilities of making the smart phone smarter with photonic devices described herein.

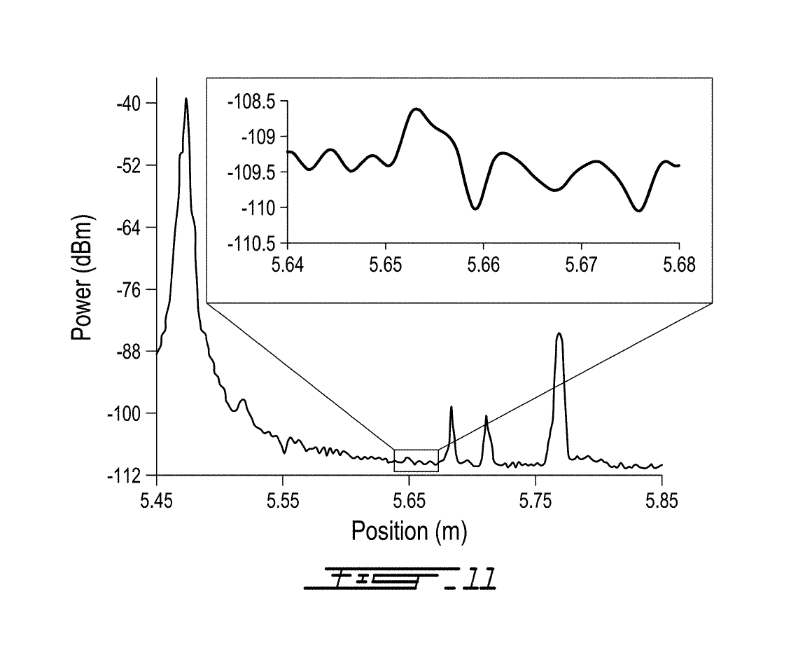

Three methods were used to make loss measurement to ensure accurate results. First, an optical backscatter reflectometer (OBR) from LUNA was used. The OBR sends a laser pulse and measures the light scattered back as a function of time, which is then converted into a time delay and therefore, position. FIG. 11 is a graph showing an example of the power (in dBm) measured by the OBR as a function of the position within a 30 cm long multi-mode waveguide inscribed according to the disclosed writing techniques. The first peak on the left is the light reflected from a connection between a single-mode fiber SMF 28 fiber and the 30 cm long multi-mode waveguide. The second peak, 30 cm further (at 5.78 m), is the reflection from an end facet of the waveguide. Note that the two small peaks at around 5.7 m are always present regardless of the sample or material, implying that these peaks come from a mode mismatch or multiple reflections in the instrument. The smoothness of the waveguide response tells us that the losses come from scattering and not from defects or other non-uniformities.

If a material is homogeneous, which is the case for toughened media glass, the propagation loss in dB/cm can be obtained through the slope of the back-scatter curve. As the laser pulse from the OBR has a certain width, it has an effect before and after the connection, so that only devices longer than ˜50 cm can be analyzed adequately. Our waveguide was not long enough to avoid the large artifact at the waveguide entrance. Therefore, the loss obtained was higher than the real value (measured by the cut-back method) but gives us a good approximation. A loss of 0.06±0.04 dB/cm at 1550 nm was obtained by zooming-into the graph. Note that the slope gives us twice the loss as the light passes twice through the waveguide due to the backscatter. Also the optical fiber used to couple the light in the multimode waveguide, can excite higher order modes and in turn generate additional loss.

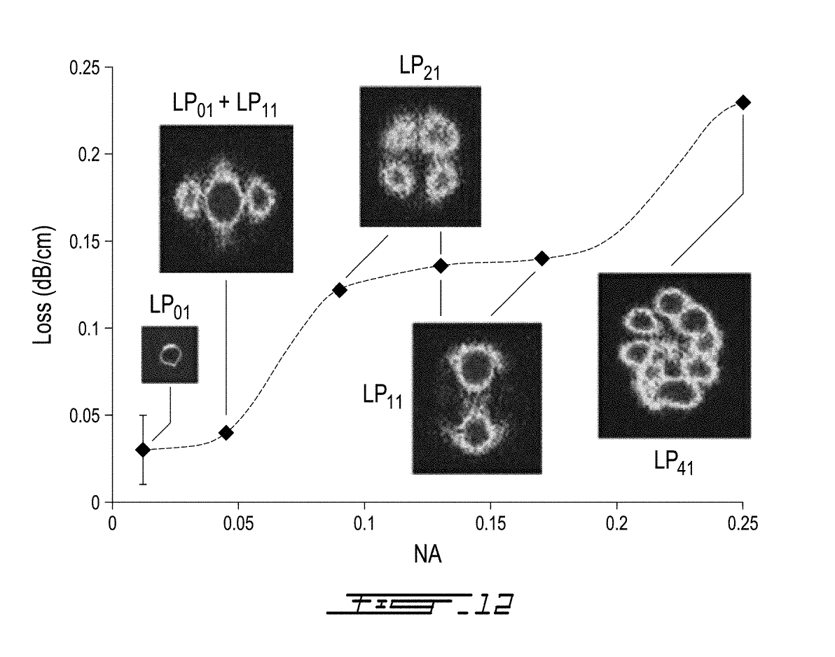

The second technique used to measure loss was by measuring the power at the input and to subtract the power at the output. Unfortunately, this method includes a Fresnel reflection and the coupling losses. To minimize the coupling losses, a lens system was used in order to find the best NA for the waveguide to be measured. FIG. 12 shows the loss and the additional modes that appear as the NA increases. With an NA of 0.25, all each mode can be excited by simply altering the launch conditions and a loss of 0.23 dB/cm is measured. However, with a lower NA, the higher order mode LP₄₁ disappears and the loss, surprisingly, reduces to between 0.1 and 0.15 dB/cm. By reducing the NA further to 0.045, lower losses of 0.04 dB/cm were obtained, with only the LP₀₁ and LP₁₁ modes present. An approximation using the waveguide output light angle gives an NA of 0.03±0.01. To reach such an NA, we used a 150 μm diameter pin hole, which give an NA of ˜0.012. Unfortunately, most of the light was cut and the fluctuation on the power meter was not negligible anymore. Therefore, this measurement was not accurate. Note that no index matching oil can be used with the lens coupling technique; no anti-reflection coating was used on the polished facets either to eliminate the Fresnel reflection losses. Depending on the polishing quality, ˜0.1 to 1 dB/facet is usually subtracted from the total loss. To polish the samples, different polishing sheets were used, and some down to a grit size of 0.3 mm. The staircase shape of the curve shown in FIG. 12 is seen in all waveguides fabricated using different laser writing parameters. To measure loss below an NA of 0.045 (or less), a third method was used, and is described below.

An approximation of the refractive index variation of the waveguide Δn=n₂−n₁=0.0003±0.0002 (as mentioned above: n₁=cladding refractive index, n₂=core refractive index) is calculated using the refractive index of the toughened media glass n₁=1.503175 [26] and the following formula:

NA≈\sqrt{n₂²−n₁²}; (3)

The third loss measurement method used is the well-known cut-back method. This method involves comparing the optical power transmitted through a long waveguide to the power transmitted through the shorter piece after cutting the waveguide. The loss in dB over the cut-off length gives the exact propagation loss excluding Fresnel reflections. A 300 mm long waveguide was cut to a 230 mm and then to a 70 mm length. Using these two pieces and comparing each one to the 300 mm long waveguide, we obtained a loss of 0.027 dB/cm. This technique is known as the most accurate but is not usually used as it is destructive. However, this was not an issue for our team as the fabrication of waveguide using the laser is very fast. To avoid any polishing non-uniformities or other problems which could have affected the results, we repeated the measurement on two other samples and obtained similar results. In the literature, 10 to 50 mm long waveguides are usually fabricated and the cut-back technique is therefore not at all accurate. This technique becomes extremely powerful applied to our longer 30 cm long devices, providing very accurate data for the first time.

Referring now more generally to possible embodiments, it was found that loss could be reduced as compared to prior art techniques by generally reducing the scattering when inscribing the waveguide. Reduce scattering can occur when inscribing a waveguide in a stress relief zone of the glass, in a heat-affected zone of the glass, by inducing lower refractive index regions in the glass and/or by using two beams instead of one, to name a few possible examples.

As can be understood, the examples described above and illustrated are intended to be exemplary only. For instance, although the embodiments described herein tend to avoid ablation, it will be understood that alternate embodiments can be performed in combination with ablation to achieve different functions or objectives. The scope is indicated by the appended claims.

1. A method for inducing a change in refractive index into a glass substrate, the method comprising:
relatively moving a femtosecond laser beam along a surface of the glass substrate while maintaining the focus of the laser beam at a given depth from the surface and obtaining a region into the glass substrate in response to said moving, the region having a refractive index different from a refractive index of the glass substrate,
wherein the glass substrate is a toughened glass.

2-7. (canceled)

8. The method of claim 1, wherein the given depth is less than 100 μm.

9. (canceled)

10. The method of claim 1, wherein the glass substrate is toughened using an ion exchange process.

11. (canceled)

12. The method of claim 1, wherein the glass substrate is an alkali-aluminosilicate glass.

13-21. (canceled)

22. The method of claim 8, wherein the given depth is less than 45 μm, preferably less than 40 μm, most preferably less than 35 μm.

23-25. (canceled)

26. The method of claim 1, wherein the femtosecond laser beam has a pulse repetition rate of 300 kHz to 2 MHz, a pulse width of above 100 fs, wherein the femtosecond laser beam is focused on the glass substrate with a numerical aperture of 0.4 to 0.8.

27-28. (canceled)

29. The method of claim 26, wherein each pulse of the femtosecond laser beam has an energy from 200 nJ to 1000 nJ.

30-33. (canceled)

34. An optical device comprising: a glass substrate of toughened glass having a region inscribed therein at a given depth from a surface of the glass, the region having a refractive index different from a refractive index of the glass substrate.

35-40. (canceled)

41. The optical device of claim 34 wherein the given depth is less than 100 μm.

42. (canceled)

43. The optical device of claim 34, wherein the glass substrate is toughened using an ion exchange process.

44-45. (canceled)

46. The optical device of claim 34, wherein the glass substrate is an alkali-aluminosilicate glass.

47-50. (canceled)

51. The optical device of claim 81, wherein the waveguide is single-mode and has a loss of less than 0.08 dB/cm, preferably less than or equal to 0.07 dB/cm, most preferably less than 0.06 dB/cm, when measured at a wavelength of light signal propagating in the waveguide during normal use of the waveguide.

52. The optical device of claim 81, wherein the waveguide is multi-mode and has a loss of less than 0.08 dB/cm, preferably less than or equal to 0.06 dB/cm, most preferably less than 0.03 dB/cm, when measured at a wavelength of light signal propagating in the waveguide during normal use of the waveguide.

53. (canceled)

54. The optical device of claim 41, wherein the given depth is less than 45 μm, preferably less than 40 μm, most preferably less than 35 μm.

55. The optical device of claim 34, wherein the resulting waveguide is in contact with the surface of the glass substrate, and wherein the surface is unablated.

56-78. (canceled)

79. The method of claim 1 wherein the region includes a waveguide.

80. The method of claim 1 wherein the region includes a grating.

81. The optical device of claim 34 wherein the region includes a waveguide.

82. The optical device of claim 34 wherein the region includes a grating.

83. The optical device of claim 34, wherein the region is invisible to the naked eye.
